(19) United States
(12) Patent Application Publication
(10) Pub. No.: US 2026/0371043 A1
(43) Pub. Date: Nov. 19, 2026

(54) Methods And Apparatus For Performing UE-To-UE Sensing Operation In Mobile Communications

(71) Applicant: MediaTek Singapore Pte. Ltd., Singapore (SG)

(72) Inventors: Wenze Qu, Beijing (CN); Min Lei, Beijing (CN); Tao Chen, Beijing (CN); Shiauhe Shawn Tsai, San Jose, CA (US)

(73) Assignee: MediaTek Singapore Pte. Ltd., Singapore (SG)

(21) Appl. No.: 19/667,651

(22) Filed: May 5, 2026

(30) Foreign Application Priority Data
May 13, 2025 (WO) PCT/CN2025/094457
Apr. 28, 2026 (CN) 202610578347.7

(51) Int. Cl. H04W 4/38

(52) U.S. Cl. CPC H04W 4/38

(57) ABSTRACT

Various solutions for performing User Equipment (UE)-to-UE sensing operation with respect to an apparatus in mobile communications are described. The apparatus may select at least one first UE for a sensing operation. The apparatus may transmit a first sensing configuration to the at least one first UE for performing the sensing operation involving the at least one first UE. The apparatus may receive a sensing result from the at least one first UE.

### CROSS REFERENCE TO RELATED PATENT APPLICATIONS

The present disclosure is part of a non-provisional application claiming the priority benefit of PCT Application No. PCT/CN2025/094457, filed on 13 May 2025, PCT Application No. PCT/CN2025/104513, filed on 27 Jun. 2025, and CN Application No. 202610578347.7, filed 28 Apr. 2026, the contents of which herein being incorporated by reference in their entirety.

### TECHNICAL FIELD

The present disclosure is generally related to mobile communications and, more particularly, to performing User Equipment (UE)-to-UE sensing operation with respect to apparatus in mobile communications.

### BACKGROUND

Unless otherwise indicated herein, approaches described in this section are not prior art to the claims listed below and are not admitted as prior art by inclusion in this section.

In beyond fifth-generation/sixth-generation (B5G/6G) mobile communication systems, Integrated Sensing and Communication (ISAC) has been introduced to enable wireless networks to support both communication services and radar sensing functionalities. In particular, network nodes and User Equipment (UE) may be equipped with sensing capabilities to perform operations such as target detection, ranging, positioning, and environment awareness by reusing communication signals or by transmitting dedicated sensing signals.

In some scenarios, existing mobile communication systems support sensing-related operations between a UE and a network node (e.g., a Base Station), where the UE and the network node may perform sensing by reusing communication signals or by transmitting dedicated reference signals. However, existing mobile communication systems do not clearly define procedures for supporting UE-to-UE sensing operations, which may improve sensing coverage and flexibility.

Accordingly, there is a need to provide appropriate mechanisms that enable efficient and flexible UE-to-UE sensing operations.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to performing User Equipment (UE)-to-UE sensing operation with respect to apparatus in mobile communications.

In one aspect, a method may involve an apparatus selecting at least one first UE for a sensing operation. The method may also involve the apparatus transmitting a first sensing configuration to the at least one first UE for performing the sensing operation involving the at least one first UE. The method may also involve the apparatus receiving a sensing result from the at least one first UE.

In one aspect, a method may involve a UE receiving a first sensing configuration from a network node. The method may also involve the UE performing a sensing operation for determining a first sensing result based on the first sensing configuration. The sensing operation may be performed by the UE itself or with a first UE.

In one aspect, a UE may comprise a transceiver which, during operation, wirelessly communicates with a wireless network. The apparatus may also comprise a processor communicatively coupled to the transceiver. The processor, during operation, may perform operations comprising receiving, via the transceiver, a first sensing configuration from a network node. The processor may further perform operations comprising performing a sensing operation for determining a first sensing result based on the first sensing configuration. The sensing operation may be performed by the UE itself or with a first UE.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2A is a diagram depicting example scenarios under schemes in accordance with implementations of the present disclosure.

FIG. 2B is a diagram depicting example scenarios under schemes in accordance with implementations of the present disclosure.

FIG. 3 is a diagram depicting example scenarios under schemes in accordance with implementations of the present disclosure.

FIG. 4 is a diagram depicting example scenarios under schemes in accordance with implementations of the present disclosure.

FIG. 5 is a diagram depicting example scenarios under schemes in accordance with implementations of the present disclosure.

FIGS. 6A-6C are diagrams depicting example scenarios under schemes in accordance with implementations of the present disclosure.

FIG. 7 is a diagram depicting example scenarios under schemes in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to performing User Equipment (UE)-to-UE sensing operation in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may select at least one UE for a sensing operation. After selection, the network node may transmit a sensing configuration to the at least one UE for performing the sensing operation involving the at least one UE. The at least one UE may receive the sensing configuration and perform the sensing operation based on the sensing configuration.

In some scenarios, the at least one UE may include one UE operating as both a transmitting (TX) UE and a receiving (RX) UE. This one UE may perform the sensing operation by itself based on the sensing configuration and determine a sensing result. This one UE may transmit the sensing result to the network node.

In some scenarios, the at least one UE may include one UE operating as a TX UE or an RX UE. This one UE may perform the sensing operation with another UE based on the sensing configuration for determining a sensing result. When this one UE operates as the RX UE, this one UE may transmit the sensing result to the network node.

Therefore, the network node may receive the sensing result from the at least one UE. Accordingly, a UE-to-UE sensing operation may be defined, thereby enabling improved sensing coverage and flexibility.

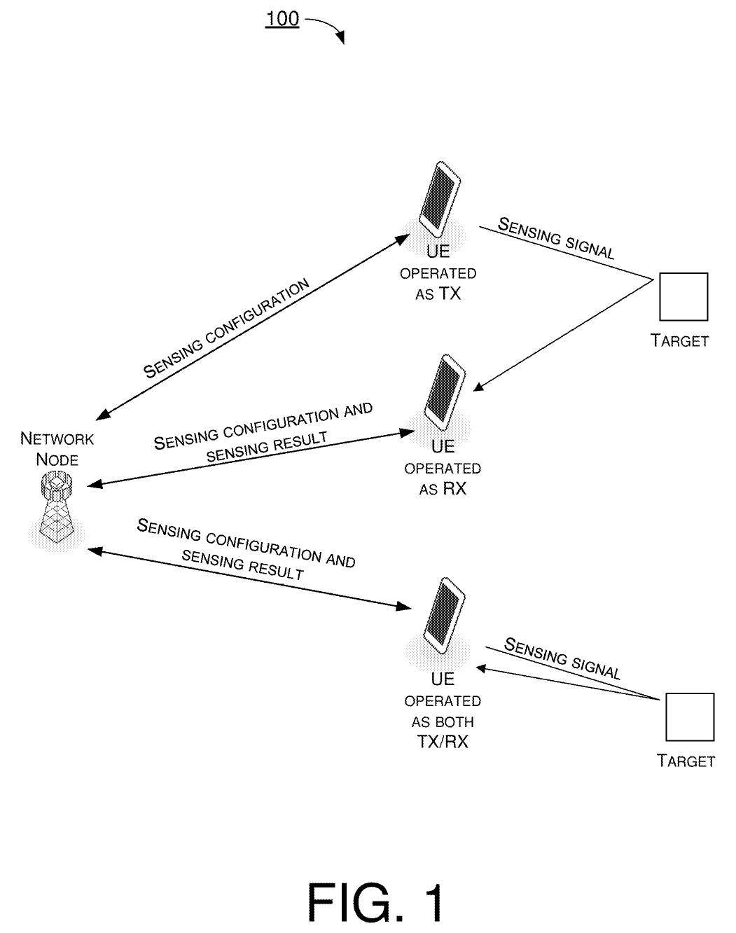

FIG. 1 illustrates an example scenario 100 under schemes in accordance with implementations of the present disclosure. Scenario 100 involves a network node and one or more UEs, which may be a part of a wireless communication network (e.g., an LTE network, a 5G/NR network, an IoT network or a 6G network). Scenario 100 illustrates the current network framework. The UEs may connect to the network node.

In some embodiments, there may be several steps for performing a UE-to-UE sensing operation. The UE-to-UE sensing operation may include at least one of: (1) a sensing operation performed by a single UE while the single UE may be configured to operate as TX UE and RX UE, and (2) a sensing operation performed by multiple UEs while one UE may be configured to operate as TX UE and another UE may be configured to operate as RX UE. The TX UE and RX UE may receive sensing configuration from the network node. The TX UE may transmit a sensing signal to a target. The RX UE may receive the reflected sensing signal and determine a sensing result. The RX UE may report the sensing result to the network node.

In particular, the steps for performing the UE-to-UE sensing operation may include the following: (1) the UEs may register with the network node and transmit UE information to the network node; (2) the network node may select at least one first UE based on the UE information for performing a sensing operation; (3) the network node may transmit a first sensing configuration to the at least one first UE for performing the sensing operation involving the at least one first UE (i.e., for performing the UE-to-UE sensing operation); (4) after receiving the first sensing configuration, the at least one first UE may perform a sensing operation for determining a first sensing result based on the first sensing configuration while the sensing operation may be performed by one UE or multiple UEs; (5) the at least one first UE may report the first sensing result to the network node; (6) the network node may update UE(s) (i.e., reselect at least one second UE) for performing the sensing operation based on the received first sensing result, and (7) the network node may reconfigure the updated UE(s) (i.e., transmit a second sensing configuration to the at least one second UE for performing the sensing operation involving the at least one second UE).

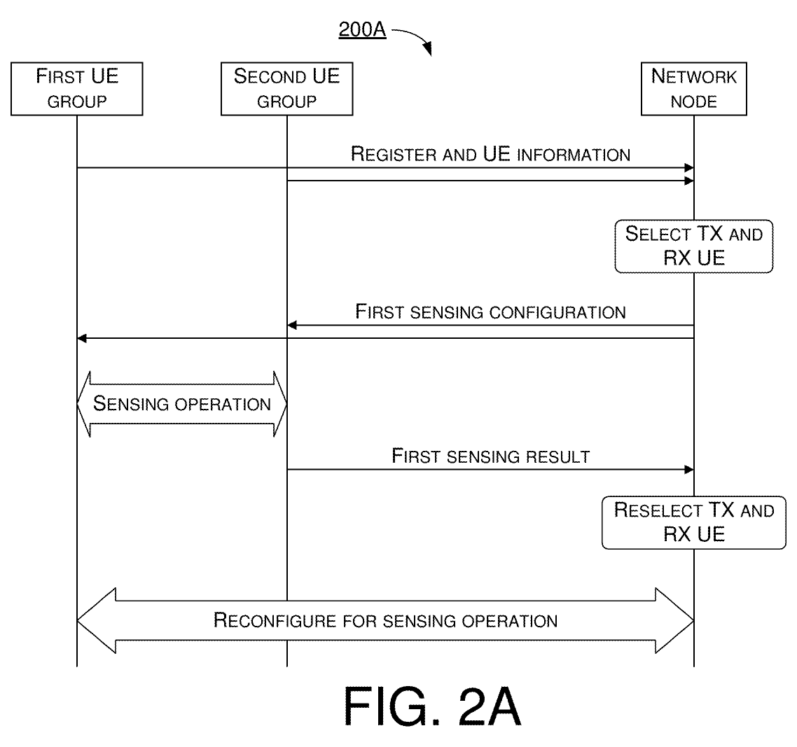

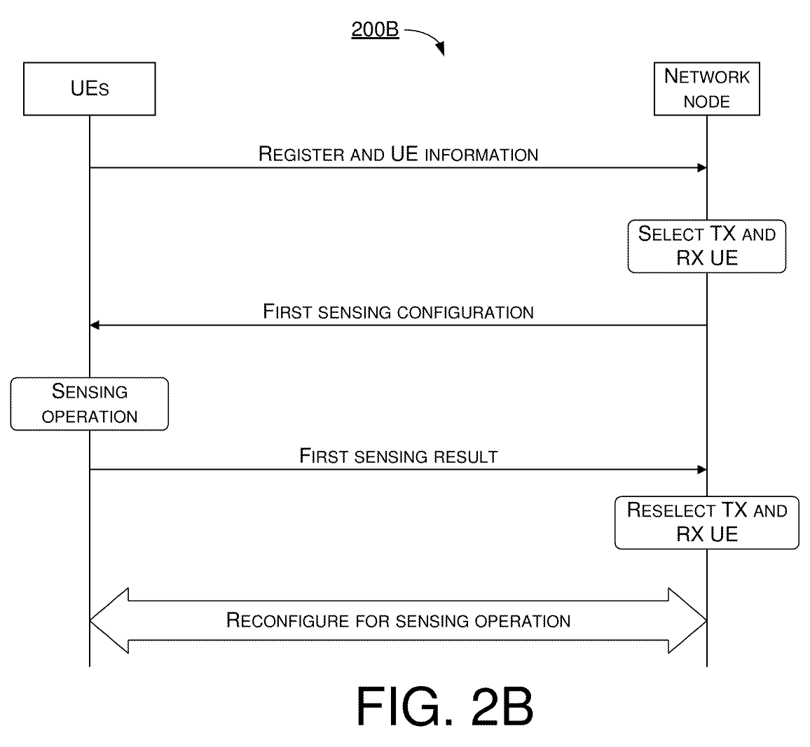

FIG. 2A illustrates an example scenario 200A under schemes in accordance with implementations of the present disclosure. For example, UEs register with the network node and transmit UE information to the network node. The network node selects one or more first UEs to form a first UE group and one or more second UEs to form a second UE group. The one or more first UEs in the first UE group are selected as TX UEs, and the one or more second UEs in the second UE group are selected as RX UEs. The network node transmits a first sensing configuration to the one or more first UEs and the one or more second UEs for performing a sensing operation between the one or more first UEs and the one or more second UEs.

After receiving the first sensing configuration, the one or more first UE configured to operate as TX UEs and the one or more second UE configured to operate as RX UEs perform the sensing operation for determining a first sensing result based on the first sensing configuration. The one or more second UE configured to operate as the RX UEs report the first sensing result to the network node. The network node updates (e.g., reselects) UE(s) for performing the sensing operation based on the received sensing result. The network node reconfigures the updated (e.g., reselected) UE(s) for further sensing operation.

FIG. 2B illustrates an example scenario 200B under schemes in accordance with implementations of the present disclosure. For example, UEs register with the network node and transmit UE information to the network node. The network node selects a UE based on the UE information for performing a sensing operation. The network node transmits a first sensing configuration to the UE for performing the sensing operation by the UE itself.

After receiving the first sensing configuration, the UE configured to operate as both a TX and an RX performs the sensing operation for determining a first sensing result based on the first sensing configuration. The UE reports the first sensing result to the network node. The network node updates (e.g., reselects) UE(s) for performing the sensing operation based on the received sensing result. The network node reconfigures the updated (e.g., reselected) UE(s) for further sensing operation.

It should be noted that, although the above examples respectively describe a UE operating as both a TX UE and an RX, and a scenario in which one UE operates as a TX UE and another UE operates as an RX UE, such examples are not intended to limit the present disclosure. A person skilled in the art should readily appreciate, based on the present disclosure, that different scenarios may involve different configurations. For example, in some scenarios, at least one UE may operate as both a TX UE and an RX UE, while at least one other UE operates as a TX UE or an RX UE.

In some implementations, with respect to the step of that the UEs may register with the network node and transmit the UE information to the network node, each UE information corresponding to one UE may include a UE capability and a UE position.

In some cases, the UE capability may include information of: (1) whether the corresponding UE supports UE-to-UE sensing operation, (2) whether the corresponding UE can be a TX UE and/or an RX UE, and (3) a capability of sensing signal transmission and reception and sensing signal processing. It should be noted that the TX UE may be defined as a UE that may transmit sensing signals and the RX UE may be defined as a UE that may receive sensing signals.

In some cases, the UE capability may include: (1) user consent, indicating a willingness to report sensing results and position information, and (2) real-time status (e.g., battery power, channel conditions, etc.).

In some cases, the UE position may include Global Navigation Satellite System (GNSS) information reported by the UE. In some cases, the UE position may be obtained by the network node through a positioning procedure between the corresponding UE and the network node.

In some implementations, with respect to the step where the network node may select the at least one first UE based on the UE information for performing the sensing operation, the network node may select the at least one first UE and determine the role of the TX UE and the RX UE. In particular, the network node may select the at least one first UE to perform a UE-to-UE sensing operation based on reported UE capability and UE position, and determine, for the at least one first UE, whether the at least one first UE is to operate as a TX UE, an RX UE, or both.

For example, with respect to FIG. 2A, the one or more first UEs in a first UE group are configured to operate as TX UEs, and the one or more second UEs in the second UE group are configured to operate as RX UEs, and the roles of the first UE group and the second UE group may be interchanged.

It should be noted that each of some UEs in the first UE group and/or the second UE group may be configured to operate as both a TX UE and an RX UE. For example, in scenarios requiring multiple sensing signal transmission and reception operations, the UEs in the first UE group and/or the second UE group alternately transmit sensing signals to each other.

In some implementations, with respect to the step where the network node may transmit the first sensing configuration to the at least one first UE for performing the sensing operation, the network node may configure the at least one first UE sensing service requirement and/or sensing signal configuration. In particular, the first sensing configuration may include at least one of: (1) a sensing service requirement, (2) an indication of TX UE and RX UE, and (3) a sensing signal configuration.

In some cases, the sensing service requirement may include at least one of a sensing measurement quantity information, a performance requirement, and a sensing task priority (e.g., high, middle, or low). In some cases, the indication of TX UE and RX UE may indicate the at least one first UE to operate as a TX UE, an RX UE, or both. In some cases, the sensing signal configuration may include at least one of a sensing signal pattern, a time and frequency resource information, a beamforming related configuration, and a transmitting and receiving indication (e.g., corresponding UE may transmit or receive sensing signals).

In some cases, when the sensing signal configuration conflicts with system configurations or communication signals, the at least one first UE may be configured to resolve the conflict based on at least one predefined rule.

In particular, the conflict may include: (a) a conflict between a transmitting direction or a receiving direction of a sensing signal and an Uplink (UL) and Downlink (DL) Configuration (UDC) of a communication system, and/or (b) a conflict between a sensing signal and UL and DL data and Reference Signals (RSs) of the communication system.

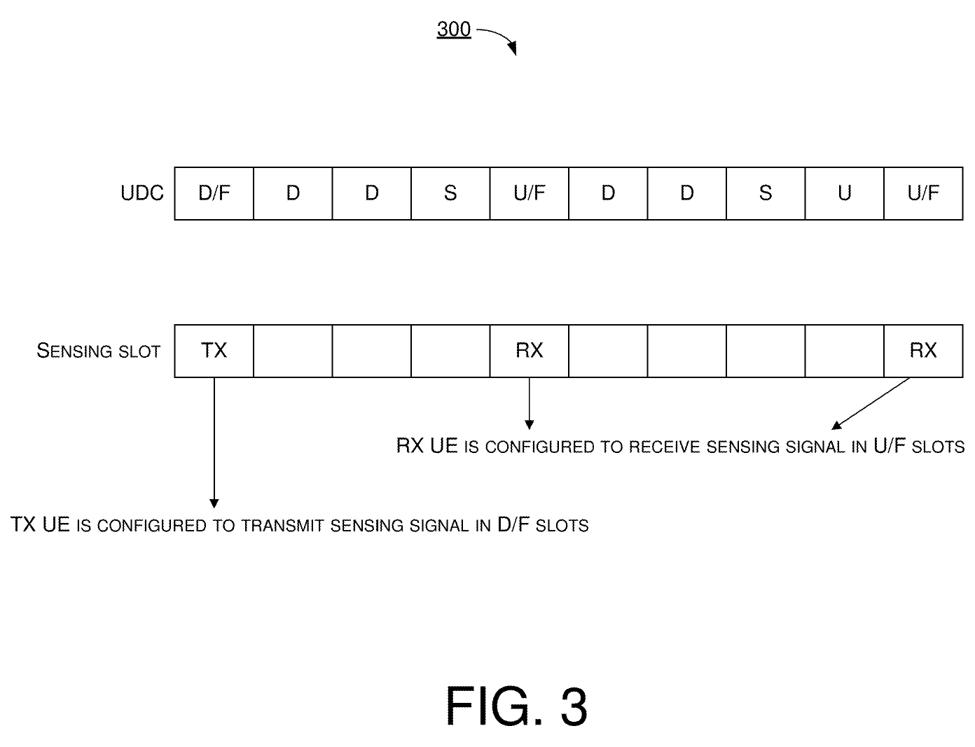

More specifically, when the sensing task priority is higher than communications and the above conflict (a) occurs, the at least one first UE may apply the sensing signal configuration. FIG. 3 illustrates an example scenario 300 under schemes in accordance with implementations of the present disclosure. For example, a UDC configures several slots, where ‘U’ represents the UL slot, ‘D’ represents the DL slot, ‘U/F’ represents the UL and flexible slot, ‘D/F’ represents the DL and flexible slot, and ‘S’ represents the sensing slot.

In this example, one or more slots are configured as UL or flexible slots by UDC, and the sensing signal configuration configures the at least one first UE to receive the sensing signal in the one or more slots. In such scenario, the at least one first UE (e.g., UE configured to operate as an RX UE) applies the sensing signal configuration and receives sensing signals in the one or more slots. For another example, one or more slots are configured as DL or flexible slots by UDC, and the sensing signal configuration configures the at least one first UE to transmit the sensing signal in the one or more slots. In such scenario, the at least one first UE (e.g., UE configured to operate as a TX UE) applies the sensing signal configuration and transmits sensing signals in the one or more slots.

In addition, when determining the sensing signal configuration, the network node may attempt to align a transmitting and receiving configuration of the sensing signal with the UDC. For example, one or more flexible slots are defined in the UDC, and the network node configures the at least one first UE to perform sensing signal transmission and reception in the one or more flexible slots. When the sensing task priority is high, the at least one first UE applies the transmitting and receiving configuration of the sensing signal to determine an operation, including transmitting or receiving, in the one or more flexible slots.

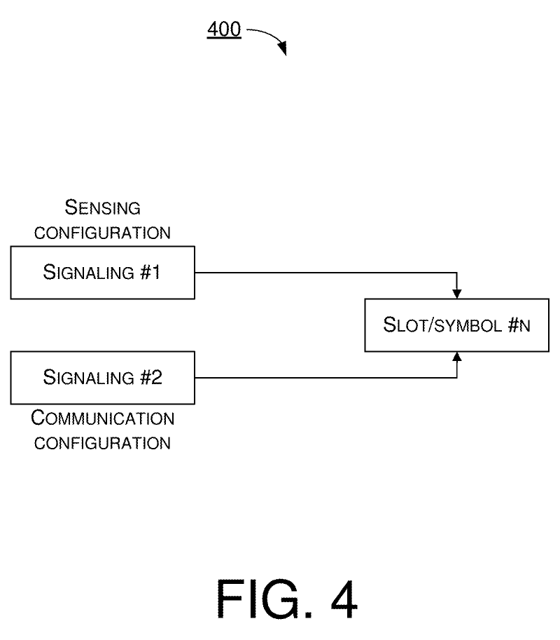

FIG. 4 illustrates an example scenario 400 under schemes in accordance with implementations of the present disclosure. When a Slot #n (or Symbol #n) is configured for both sensing (e.g., signal #1 configured by sensing configuration) and communication (e.g., signal #2 configured by communication configuration), but the sensing operation and a communication operation may not be performed simultaneously, the at least one first UE may perform one of the sensing operation or the communication operation based on the sensing task priority and/or at least one predefined rule.

More specifically, when the sensing task priority is higher than communications and the above conflict (b) occurs, the sensing signal configuration may configure the at least one first UE to receive sensing signal in one or more slots, and UL data and RSs of the communication system (e.g., Physical Uplink Control Channel (PUCCH), Physical Uplink Shared Channel (PUSCH), or Sounding Reference Signal (SRS)) may not be transmitted in the one or more slots.

For example, when DL data or RSs of the communication system (e.g., Physical Downlink Control Channel (PDCCH), Physical Downlink Shared Channel (PDSCH), Channel State Information-RS (CSI-RS) for tracking, and CSI-RS for Channel Quality Indicator (CQI)) cannot be frequency-division multiplexed (i.e., FDMed) with the sensing signal, the at least one first UE does not receive the DL data or RSs of the communication system.

Further, when the sensing task priority is higher than communications and the above conflict (b) occurs, the sensing signal configuration may configure the at least one first UE to transmit the sensing signal in one or more slots, and DL data and RSs of the communication system (e.g., PDCCH, PDSCH, CSI-RS for tracking, CSI-RS for CQI) may not be received in the one or more slots.

For example, when UL data and RSs of the communication system (e.g., PUCCH, PUSCH, SRS) cannot be FDMed with the sensing signal, the at least one first UE does not transmit the UL data or RSs of the communication system.

It should be noted that, in the above cases and examples, one or more slots may alternatively be expressed as one or more symbols.

In some implementations, with respect to the step of that the at least one first UE may perform the sensing operation for determining the first sensing result based on the first sensing configuration while the sensing operation may be performed by one UE or multiple UEs, the at least one first UE may transmit and/or receive sensing signals, process the sensing signals, and calculate sensing data (i.e., determine sensing result).

In some cases, timing may be controlled between the at least one first UE. In particular, when the at least one first UE includes a TX UE and an RX UE separately, the TX UE may apply UL timing of the communication system (e.g., the TX UE may directly apply UL timing of the communication system, such as UL timing of SRS) when transmitting the sensing signal. A sensing reception window may be defined for the RX UE to receive the sensing signal from the TX UE. For example, the sensing reception window is determined based on the UE DL reference timing in a serving cell and an additional length. The additional length covers a timing offset between UE UL timing and DL timing, a timing error between the RX UE and the TX UE, and a timing error between the network nodes (if the TX UE and the RX UE are deployed in different cells). In some cases, the additional length may be configured by the network node or pre-defined.

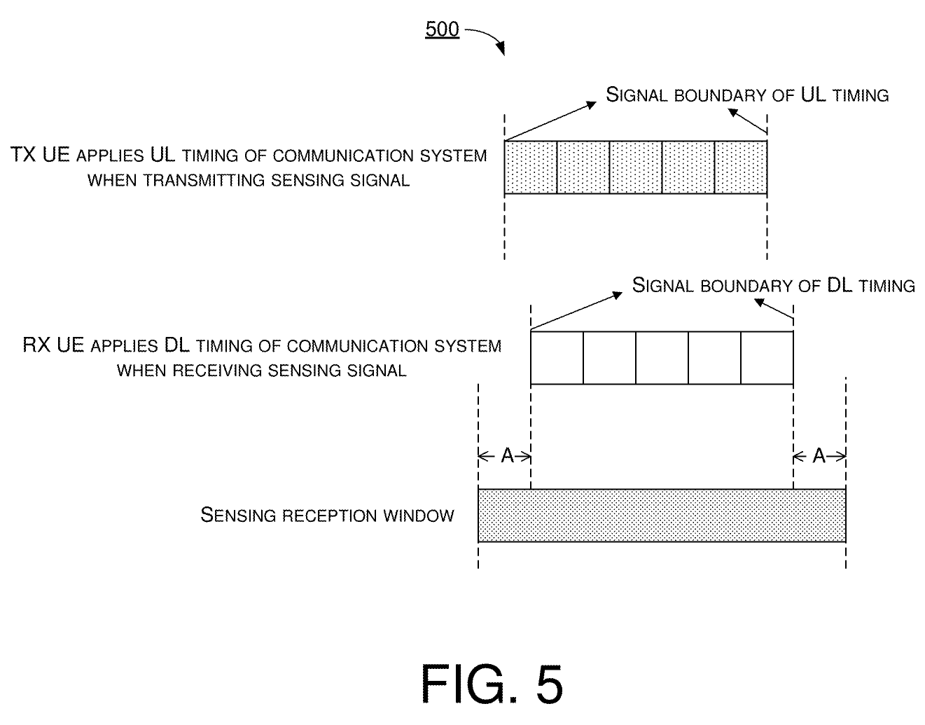

FIG. 5 illustrates an example scenario 500 under schemes in accordance with implementations of the present disclosure. For example, the TX UE applies UL timing of the communication system when transmitting the sensing signal (e.g., 5 symbols). The RX UE applies the DL timing of the communication system when receiving the sensing signal (e.g., 5 symbols). There are offsets between a signal boundary of the DL timing and a signal boundary of the UL timing. A sensing reception window is defined for the RX UE to receive the sensing signal from the TX UE. The sensing reception window is determined based on UE DL reference timing and an additional length (corresponding to twice a value “A” as illustrated in FIG. 5). The additional length covers the offsets.

In some cases, power may be controlled for the at least one first UE. In particular, when the at least one first UE may include a TX UE, the TX UE may apply UL transmitting power of the communication system (e.g., the TX UE may directly apply UL transmitting power of the communication system, such as UL transmitting power SRS) for transmitting the sensing signal.

Alternatively, when the at least one first UE includes a TX UE and an RX, a transmitting power for the TX UE to transmit the sensing signal may be adjusted based on sensing data reported by the RX UE (e.g., sensing Signal-to-Interference-plus-Noise Ratio (SINR)). More specifically, the network node may configure the TX UE with an initial transmitting power. The TX UE and the RX UE may perform the sensing operation based on the initial transmitting power. The RX UE may report sensing data to the network node. The network node may update the initial transmitting power and configure the TX UE with the updated transmitting power. The TX UE may adjust the transmitting power for transmitting the sensing signal.

In some cases, Beam Management (BM) may be performed by the at least one first UE. In particular, the at least one first UE may include a TX UE and an RX UE separately. The TX UE and the RX UE may have analog beams (e.g., under Frequency Range 2 (FR2)). A multiple-stage BM procedure may be used.

More specifically, in a first stage of the BM procedure, the network node may configure the TX UE and the RX UE with sensing signals for the first stage. The sensing signals of the first stage may have multiple coarse TX beams and may be transmitted with repetitions to enable the RX UE to perform RX beam sweeping. The TX UE may transmit the sensing signals. The RX UE may receive the sensing signals with RX beam sweeping. The RX UE may report sensing data to the network node. The sensing data may have information of a detected target and information of the corresponding TX beam (e.g., resource set identification ID).

In a second stage of the BM procedure, the network node may update the sensing signal configuration for the TX UE and RX UE. The updated sensing signal of the second stage may include multiple fine TX beams corresponding to reported coarse TX beams. The TX UE and the RX UE may perform the sensing operation based on the updated sensing signal.

In a third stage of the BM procedure, the network node may further update the sensing signal configuration for the RX UE to find the fine RX beams.

In some cases, a procedure of sensing signal transmission and reception may be performed by the at least one first UE. In particular, the at least one first UE may include a TX UE and an RX UE separately. It is possible to include one or more times of sensing signal transmission and reception between the TX UE and RX UE. Moreover, the roles of the TX UE and RX UE may be interchanged in the procedure. For example, Round-Trip Time (RTT) measurement between UEs requires the TX UE and RX UE to transmit signals to each other.

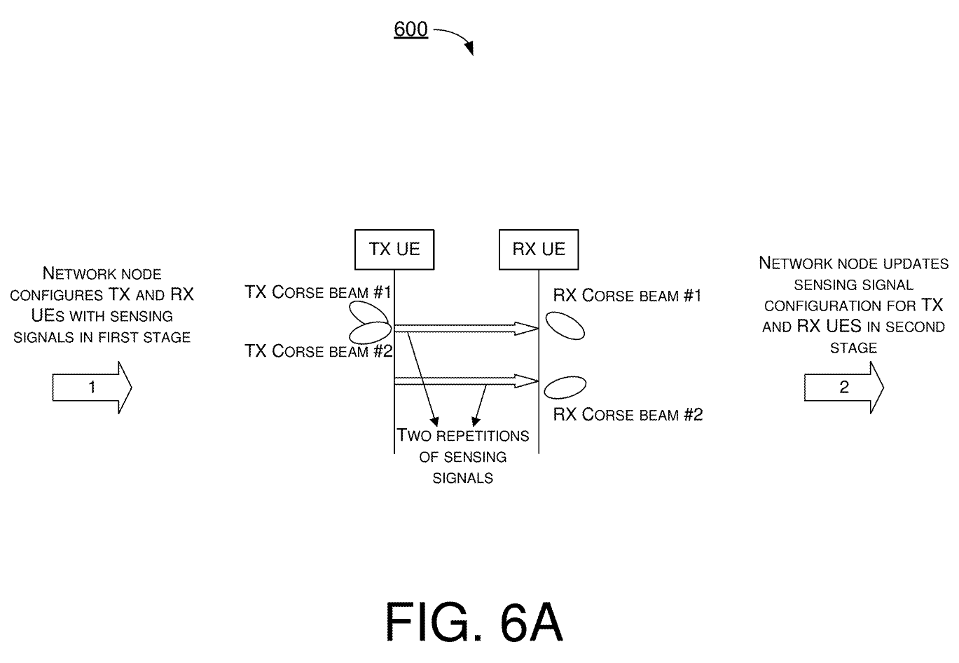

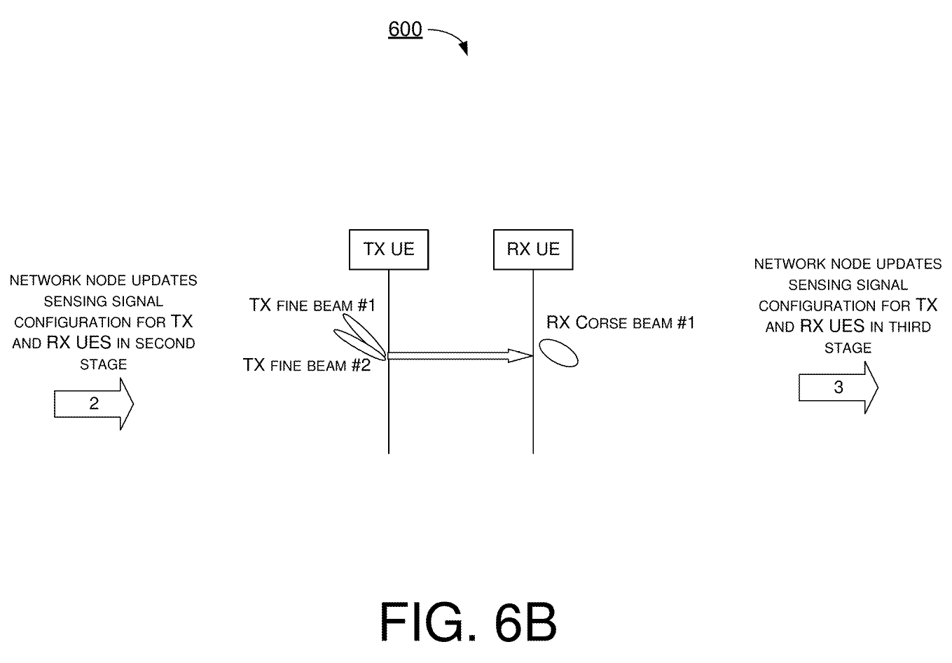

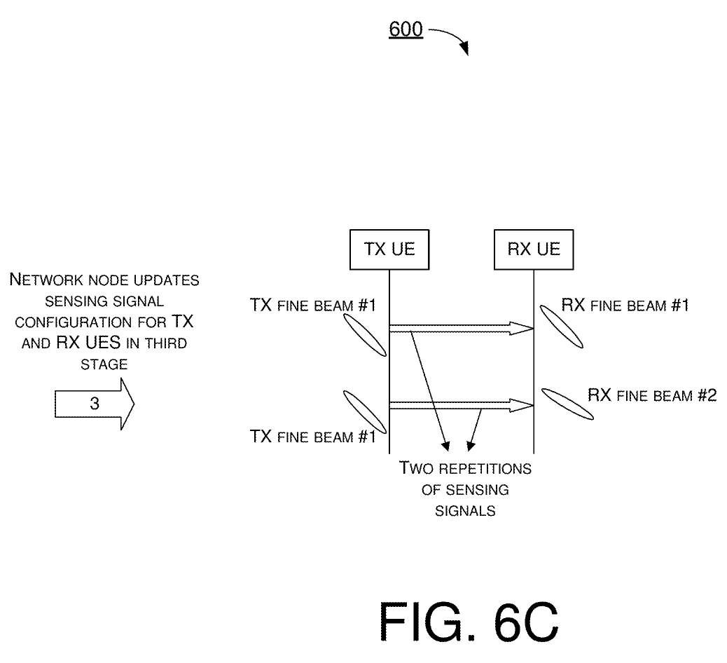

FIGS. 6A-6C illustrate an example scenario 600 under schemes in accordance with implementations of the present disclosure. For example, in the first stage of the BM procedure, the network node configures the TX UE and the RX UE with sensing signals for the first stage. The sensing signals of the first stage have two coarse TX beams (i.e., TX coarse beams #1 and #2) and are transmitted with two repetitions to enable the RX UE to perform RX beam sweeping. The TX UE transmits the sensing signals. The RX UE receives the sensing signals with RX beam sweeping. Two repetitions are received by different RX coarse beams (i.e., RX coarse beams #1 and #2). In this example, a target is detected on the sensing signal corresponding to TX coarse beam#1 with RX coarse beam#1. The RX UE reports sensing data to the network node. The sensing data includes information of a detected target and information of the corresponding TX beam (e.g., resource set identification ID).

In a second stage of the BM procedure, the network node updates the sensing signal configuration for the TX UE and RX UE. The updated sensing signal of the second stage includes two TX fine beams (i.e., TX fine beams #1 and #2) corresponding to reported TX coarse beam #1. The TX UE and the RX UE perform the sensing operation based on the updated sensing signal. In this example, a target is detected with better sensing SINR on the sensing signal corresponding to TX fine beam#1 with RX coarse beam#1.

In a third stage of the BM procedure, the network node further updates the sensing signal configuration for the RX UE to find the fine RX beams. The sensing signals of the third stage have one fine TX beam (i.e., TX fine beam #1) and are transmitted with two repetitions to enable the RX UE to perform RX beam sweeping. The TX UE transmits the sensing signals. The RX UE receives the sensing signals with RX beam sweeping. Two repetitions are received by different RX fine beams (i.e., RX fine beams #1 and #2). In this example, a target is detected with better sensing SINR on the sensing signal corresponding to TX fine beam#1 with RX fine beam#1.

In some cases, a procedure of sensing signal transmission and reception may be performed by the at least one first UE. In particular, the at least one first UE may include a TX UE and an RX UE separately. It is possible to include one or more times of sensing signal transmission and reception between the TX UE and RX UE. Moreover, the roles of the TX UE and RX UE may be interchanged in the procedure.

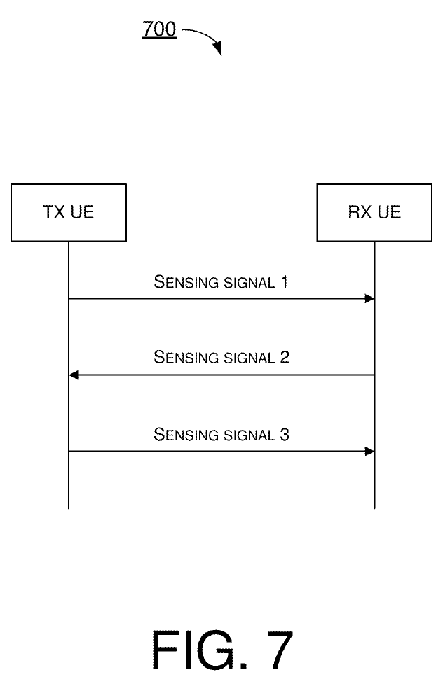

FIG. 7 illustrates an example scenario 700 under schemes in accordance with implementations of the present disclosure. For example, Round-Trip Time (RTT) measurement between UEs requires the TX UE and RX UE to transmit sensing signals (i.e., sensing signals 1 to 3) to each other.

In some implementations, with respect to the step where at least one first UE may report the first sensing result to the network node, the RX may report the first sensing result to the network node. In particular, when the at least one first UE includes a UE configured to operate as both a TX UE and an RX UE, the UE may determine the first sensing result and report the first sensing result to the network node. When the at least one first UE includes a UE configured to operate as an RX UE, the UE may determine the first sensing result and report the first sensing result to the network node. The reporting may be periodic, event-triggered periodic, or event-triggered. The reporting may include information of the detected target (e.g., delay, doppler, angle), sensing SINR, resource identification or resource set identification, etc.

In some implementations, with respect to the step where the network node may update UE(s) (i.e., reselect at least one second UE) for performing the sensing operation based on the received first sensing result, time/frequency resource, power and analog beam of sensing signal may be updated. In some cases, the updated UE(s) (i.e., the reselected at least one second UE) may be identical to, partially overlap with, or be different from the at least one first UE.

In some implementations, with respect to the step of that the network node may reconfigure the updated UE(s), the updated UE(s) may perform the sensing operation and report the new sensing result. In particular, the updated UE(s) may perform the previous steps (3) to (5). More specifically, the network node may transmit a second sensing configuration to the updated UE(s). The updated UE(s) may receive the second sensing configuration from the network node. The updated UE(s) may perform the sensing operation to determine a second sensing result based on the second sensing configuration. The updated UE(s) may transmit the second sensing result to the network. The network node may further update UE(s) for performing the sensing operation based on the received second sensing result.

### Illustrative Implementations

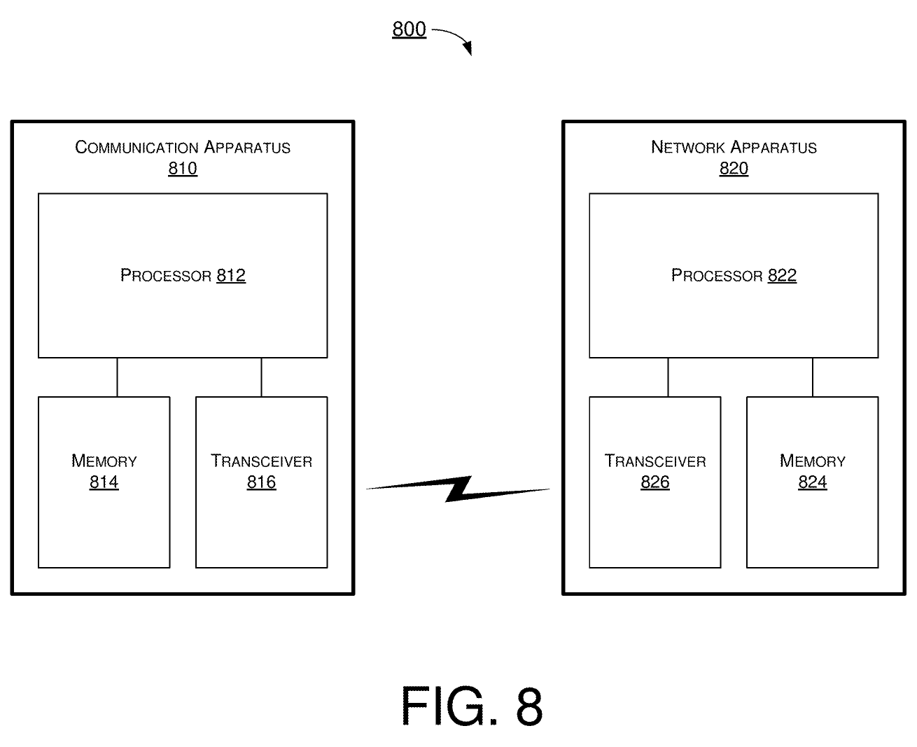

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to performing UE-to-UE sensing operation with respect to UE and network apparatus in mobile communications, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer or a notebook computer. Communication apparatus 810 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router or a gateway. For instance, network apparatus 820 may be implemented in an eNodeB in an LTE network, in a gNB in a 5G/NR, IoT, NB-IoT or IIoT network or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including performing UE-to-UE sensing operation in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In other words, processor 812 may transceive the data such as configuration, message, signal, information, indicator, etc. via transceiver 816. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In other words, processor 822 may transceive the data such as configuration, message, signal, information, indicator, etc. via transceiver 826. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

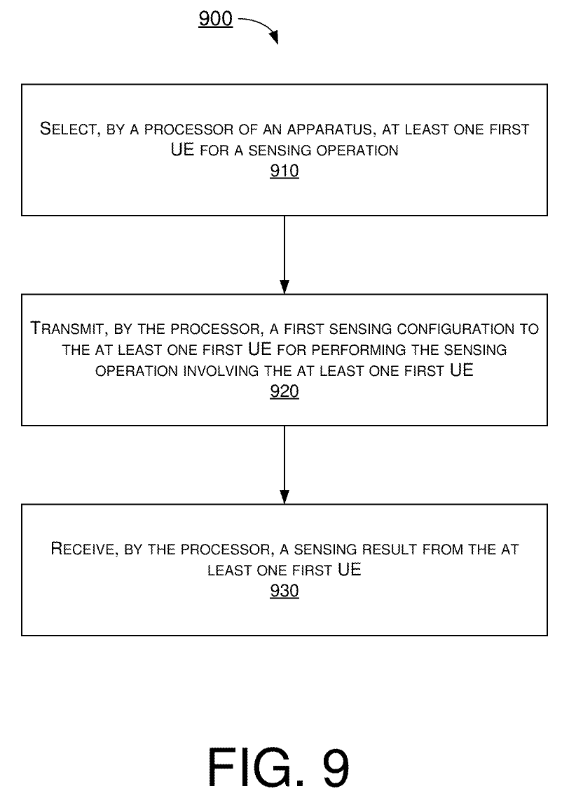

FIG. 9 illustrates an example process 900 in accordance with an implementation of the present disclosure. Process 900 may be an example implementation of above scenarios/schemes, whether partially or completely, with respect to performing UE-to-UE sensing operation of the present disclosure. Process 900 may represent an aspect of implementation of features of network apparatus 820. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by network apparatus 820 or any suitable network device or machine type devices. Solely for illustrative purposes and without limitation, process 900 is described below in the context of network apparatus 820. Process 900 may begin at block 910.

At block 910, process 900 may involve processor 822 of network apparatus 820 selecting at least one first UE for a sensing operation. Process 900 may proceed from block 910 to block 920.

At block 920, process 900 may involve processor 822 of network apparatus 820 transmitting a first sensing configuration to the at least one first UE for performing the sensing operation involving the at least one first UE. Process 900 may proceed from block 920 to block 930.

At block 930, process 900 may involve processor 822 of network apparatus 820 receiving a sensing result from the at least one first UE.

In some implementations, the at least one first UE may include: (1) one UE selected to operate as both a TX UE and an RX UE for performing the sensing operation; or (2) one UE selected to operate as a TX and another UE selected to operate as an RX for performing the sensing operation.

In some implementations, the first sensing configuration may include at least one of: (1) a sensing service requirement, (2) an indication of TX UE and RX UE, and (3) a sensing signal configuration.

In some implementations, the sensing service requirement may include at least one of a sensing measurement quantity information, a performance requirement, and a sensing task priority.

In some implementations, the indication of TX UE and RX UE may indicate the at least one first UE to operate as a TX UE, an RX UE, or both.

In some implementations, the sensing signal configuration may include at least one of a sensing signal pattern, a time and frequency resource information, a beamforming related configuration, and a transmitting and receiving indication.

In some implementations, process 900 may further involve processor 822 of network apparatus 820 receiving at least one UE information from the at least one first UE. The at least one first UE may be selected based on the at least one UE information.

In some implementations, each of the at least one UE information may include a UE capability and a UE position.

In some implementations, process 900 may further involve processor 822 of network apparatus 820 reselecting at least one second UE for performing the sensing operation based on the first sensing result.

In some implementations, process 900 may further involve processor 822 of network apparatus 820 transmitting a second sensing configuration to the at least one second UE for performing the sensing operation involving the at least one second UE.

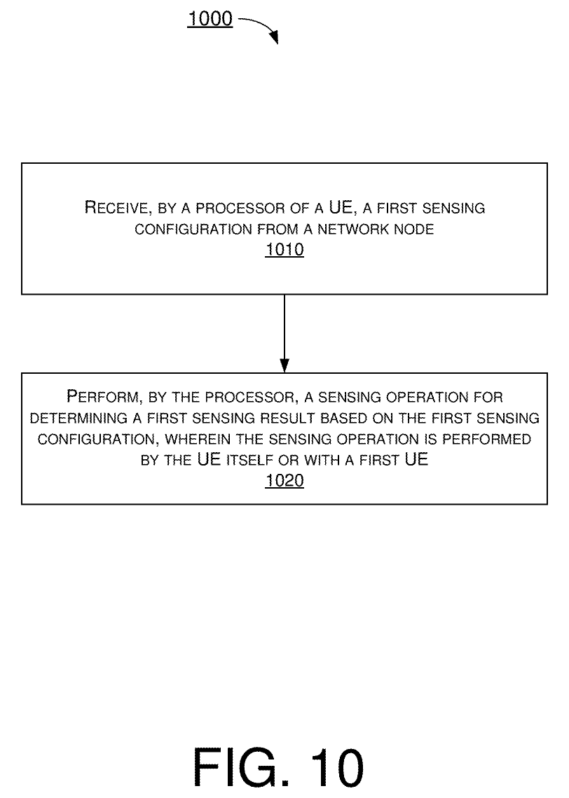

FIG. 10 illustrates an example process 1000 in accordance with an implementation of the present disclosure. Process 1000 may be an example implementation of above scenarios/schemes, whether partially or completely, with respect to performing UE-to-UE sensing operation of the present disclosure. Process 1000 may represent an aspect of implementation of features of communication apparatus 810. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by communication apparatus 810 or any suitable UE or machine type devices. Solely for illustrative purposes and without limitation, process 1000 is described below in the context of communication apparatus 810. Process 1000 may begin at block 1010.

At block 1010, process 1000 may involve processor 812 of communication apparatus 810 receiving a first sensing configuration from a network node. Process 1000 may proceed from block 1010 to block 1020.

At block 1020, process 1000 may involve processor 812 of communication apparatus 810 performing a sensing operation for determining a first sensing result based on the first sensing configuration. The sensing operation may be performed by communication apparatus 810 itself or with a first UE.

In some implementations, process 1000 may further involve processor 812 of communication apparatus 810 transmitting the first sensing result to the network node.

In some implementations, the first sensing configuration may include at least one of: (1) a sensing service requirement, (2) an indication of TX UE and RX UE, and (3) a sensing signal configuration.

In some implementations, the sensing service requirement may include at least one of a sensing measurement quantity information, a performance requirement, and a sensing task priority.

In some implementations, the indication of TX UE and RX UE may indicate the at least one UE to operate as a TX UE, an RX UE, or both.

In some implementations, the sensing signal configuration may include at least one of a sensing signal pattern, a time and frequency resource information, a beamforming related configuration, and a transmitting and receiving indication.

In some implementations, process 1000 may further involve processor 812 of communication apparatus 810 transmitting a UE information to the network node for UE selection.

In some implementations, the UE information may include a UE capability and a UE position.

In some implementations, process 1000 may further involve processor 812 of communication apparatus 810 receiving a second sensing configuration from the network node. Process 1000 may further involve processor 812 of communication apparatus 810 performing the sensing operation to determine a second sensing result based on the second sensing configuration. Process 1000 may further involve processor 812 of communication apparatus 810 transmitting the second sensing result to the network node.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
selecting, by a processor of an apparatus, at least one first User Equipment (UE) for a sensing operation;
transmitting, by the processor, a first sensing configuration to the at least one first UE for performing the sensing operation involving the at least one first UE; and
receiving, by the processor, a sensing result from the at least one first UE.

2. The method of claim 1, wherein selecting the at least one first UE includes:
selecting one UE to operate as both a transmitting (TX) UE and a receiving (RX) UE for performing the sensing operation; or
selecting one UE to operate as a TX and another UE selected to operate as an RX for performing the sensing operation.

3. The method of claim 1, wherein the first sensing configuration includes at least one of:
a sensing service requirement,
an indication of transmitting (TX) UE and receiving (RX) UE, and
a sensing signal configuration.

4. The method of claim 3, wherein the sensing service requirement includes at least one of a sensing measurement quantity information, a performance requirement, and a sensing task priority.

5. The method of claim 3, wherein the indication of TX UE and RX UE indicates the at least one first UE to operate as a TX UE, an RX UE, or both.

6. The method of claim 3, wherein the sensing signal configuration includes at least one of a sensing signal pattern, a time and frequency resource information, a beamforming related configuration, and a transmitting and receiving indication.

7. The method of claim 1, further comprising:
receiving, by the processor, at least one UE information from the at least one first UE,
wherein the at least one first UE is selected based on the at least one UE information.

8. The method of claim 7, wherein each of the at least one UE information includes a UE capability and a UE position.

9. The method of claim 1, further comprising:
reselecting, by the processor, at least one second UE for performing the sensing operation based on the first sensing result.

10. The method of claim 9, further comprising:
transmitting, by the processor, a second sensing configuration to the at least one second UE for performing the sensing operation involving the at least one second UE.

11. A method, comprising:
receiving, by a processor of a User Equipment (UE), a first sensing configuration from a network node; and
performing, by the processor, a sensing operation for determining a first sensing result based on the first sensing configuration, wherein the sensing operation is performed by the UE itself or with a first UE.

12. The method of claim 11, further comprising:
transmitting, by the processor, the first sensing result to the network node.

13. The method of claim 11, wherein the first sensing configuration includes at least one of:
a sensing service requirement,
an indication of transmitting (TX) UE and receiving (RX) UE, and
a sensing signal configuration.

14. The method of claim 13, wherein the sensing service requirement includes at least one of a sensing measurement quantity information, a performance requirement, and a sensing task priority.

15. The method of claim 13, wherein the indication of TX UE and RX UE indicates the UE to operate as a TX UE, an RX UE, or both.

16. The method of claim 13, wherein the sensing signal configuration includes at least one of a sensing signal pattern, a time and frequency resource information, a beamforming related configuration, and a transmitting and receiving indication.

17. The method of claim 11, further comprising:
transmitting, by the processor, a UE information to the network node for UE selection.

18. The method of claim 17, wherein the UE information includes a UE capability and a UE position.

19. The method of claim 11, further comprising:
receiving, by the processor, a second sensing configuration from the network node;
performing, by the processor, the sensing operation to determine a second sensing result based on the second sensing configuration; and
transmitting, by the processor, the second sensing result to the network node.

20. A User Equipment (UE), comprising:
a transceiver which, during operation, wirelessly communicates with a wireless network; and
a processor communicatively coupled to the transceiver such that, during operation, the processor performs operations comprising:
receiving, via the transceiver, a first sensing configuration from a network node; and
performing a sensing operation for determining a first sensing result based on the first sensing configuration, wherein the sensing operation is performed by the UE itself or with a first UE.
